(19) United States
(12) Patent Application Publication
(10) Pub. No.: US 2026/0290719 A1
(43) Pub. Date: Sep. 24, 2026

(54) INPUT DEVICE AND SYSTEM INCLUDING INPUT DEVICE

(71) Applicant: NINTENDO CO., LTD., Kyoto (JP)

(72) Inventors: Kazuki EBIHARA, Kyoto (JP); Masato KUWAHARA, Kyoto (JP); Kochi KAWAI, Kyoto (JP); Ryohei FUJITA, Kyoto (JP)

(21) Appl. No.: 19/574,238

(22) Filed: Mar. 20, 2026

(30) Foreign Application Priority Data
Mar. 21, 2025 (JP) 2025-046662

(51) Int. Cl. H01H 13/14; H01H 13/04

(52) U.S. Cl. CPC H01H 13/14; H01H 13/04

(57) ABSTRACT

An input device includes: a keycap configured to be depressed; a movable electrode configured to move in response to depression; a ground electrode arranged facing the first electrode such that a capacitance between the electrodes changes in accordance with a depression amount; a chargeable capacitor; a sensor part configured to detect a value of a charge parameter; a switching part configured to switch connection state between a first state in which a power supply is connected to the first electrode and the first electrode is not connected to the capacitor, and a second state in which the power supply is not connected to the first electrode and the first electrode is connected to the capacitor; and a high potential electrode arranged so as to contact the movable electrode when a depression amount is great, the third electrode being connected to the power supply.

### CROSS-REFERENCE TO RELATED APPLICATION

The present application claims priority to Japanese Patent Application No 2025-046662 filed on Mar. 21, 2025, which is incorporated herein by reference in its entirety including the specifications, drawings and abstract.

### FIELD

The present disclosure relates to an input device and a system comprising an input device.

### BACKGROUND AND SUMMARY

Known is a key assembly which detects a depression amount of the key assembly based on the magnitude of capacitance generated between a conductive member which moves in response to depression of a keycap and a ground-side contact on a substrate, and which detects depression of the key assembly equal to or greater than a certain amount based on the presence or absence of conduction between the conductor which moves in response to depression of the keycap and the contact on the substrate.

In the key assembly, the depression amount of the key assembly and depression of the key assembly equal to or greater than a certain amount are detected using different detection systems. Thus, there is room for improvement regarding detection of input state in an input device for detecting input by a user.

The present disclosure includes the following embodiments.

(1) An input device, comprising:
a keycap configured to be depressed,
a first electrode configured to move in a specified direction in response to depression of the keycap,
a second electrode arranged facing the first electrode such that a capacitance between the first electrode and the second electrode changes in accordance with a depression amount of the keycap, the second electrode being connected to ground,
a chargeable capacitor,
a sensor part configured to detect a value of a charge parameter which changes in accordance with a charge amount of the capacitor,
a switching part configured to switch connection state between a first state in which a power supply and the first electrode are connected to each other and the first electrode and the capacitor are not connected to each other, and a second state in which the power supply and the first electrode are not connected to each other and the first electrode and the capacitor are connected to each other, and
a third electrode arranged so as to come into contact with the first electrode when a depression amount of the keycap is equal to or greater than a specified amount, the third electrode being connected to the power supply.

(2) The input device according to above (1), further comprising a fourth electrode arranged adjacent to a depressed surface of the keycap, the fourth electrode being electrically connected to the first electrode, wherein
the fourth electrode is configured such that, when a grounded conductor approaches thereto, a capacitance between the conductor and the fourth electrode changes.

(3) The input device according to above (1) or (2), wherein the second electrode and the third electrode are arranged facing each other with an insulation layer interposed therebetween.

(4) The input device according to above (3), wherein the second electrode is arranged within a substrate and the third electrode is arranged so as to be exposed on a surface of the substrate.

(5) The input device according to any one of above (1) to (4), wherein a surface area of the second electrode facing the first electrode is greater than a surface area of the third electrode facing the first electrode.

(6) The input device according to above (5), wherein the third electrode is formed in a shape of one or a plurality of lines.

(7) The input device according to any one of above (1) to (6), wherein the second electrode is configured so as to overlap an entirety of the first electrode when viewed in the specified direction.

(8) The input device according to any one of above (1) to (7), further comprising a movable part arranged on the specified direction side of the keycap, the movable part moving in response to depression of the keycap, wherein
the first electrode is arranged on a surface of the movable part facing the second electrode on a side opposite the keycap side.

(9) The input device according to above (8), wherein the movable part is formed of an elastic material, and
the first electrode is formed of a deformable material.

(10)The input device according to above (9), wherein the first electrode is carbon ink sintered on a surface of the movable part.

(11)The input device according to any one of above (1) to (10), wherein the specified voltage is applied to the third electrode by the power supply.

(12) A system including the input device according to any one of above (1) to (11), the system comprising:
a state detection part configured to detect an input state in the input device based on a value of
a charge parameter detected by the sensor part.

(13)The system according to above (12), wherein the state detection part detects, based on the value of the charge parameter detected by the sensor part, which of a first input state in which a grounded conductor is close to the keycap, a second input state in which the keycap is depressed, and a third input state in which the depression amount of the keycap is equal to or greater than the specified amount, the input state is.

(14)The system according to above (12) or (13), wherein the state detection part detects a depression amount of the keycap based on the value of the charge parameter detected by the sensor part. (15)The system according to any one of above (12) to (14), wherein the charge parameter is a count of times the switching part switches the connection state between the first state and the second state until the charge amount of the capacitor reaches a specified charge amount.

### BRIEF DESCRIPTION OF DRAWINGS

FIG. 1 is a cross-sectional view of an input device taken along an axis line of the input device.

FIG. 2 is an exploded perspective view of the input device.

FIG. 3 is an exploded perspective view of part of a substrate.

FIG. 4 is a plan view of the substrate.

FIG. 5 is a cross-sectional view of an input device similar to FIG. 1, showing a modification example of the input device.

FIG. 6 is a view conceptually showing the relationship between the actual configuration of the input device and a circuit.

FIG. 7 is a view showing a circuit configuration of the input device.

FIG. 8 shows the flow of positive charge in a first state, in which a first switch is turned on and a second switch is turned off.

FIG. 9 shows the flow of positive charge in a second state, in which a first switch is turned off and a second switch is turned on.

FIG. 10 is a cross-sectional view similar to FIG. 1, of the input device when a finger of a user approaches a keycap.

FIG. 11 is a cross-sectional view, similar to FIG. 1, of the input device 1 when the finger of the user is in contact with the keycap and depressing.

FIG. 12 is a cross-sectional view, similar to FIG. 1, of the input device when a movable part moves to a lower limit as a result of the finger of the user depressing the keycap.

FIG. 13, similar to FIG. 8, shows the flow of positive charge in a first state in which a first switch is turned on and a second switch is turned off.

FIG. 14, similar to FIG. 9, shows the flow of positive charge in a second state in which a first switch is turned off and a second switch is turned on.

FIG. 15 is a view showing the relationship between a position of a finger of a user, serving as a conductor for operating the input device, and a charge amount of a capacitor.

FIG. 16 is a view showing the number of repetitions of switching of switches until potential of the capacitor reaches a reference value, and a position of a finger of a user over time.

FIG. 17 is a view schematically showing a system configuration of an information processing system comprising a controller.

### DESCRIPTION OF EMBODIMENTS

Embodiments will be described in detail below with reference to the drawings. Note that in the following description, identical constituent elements have been assigned the same reference signs.

### Input Device Configuration

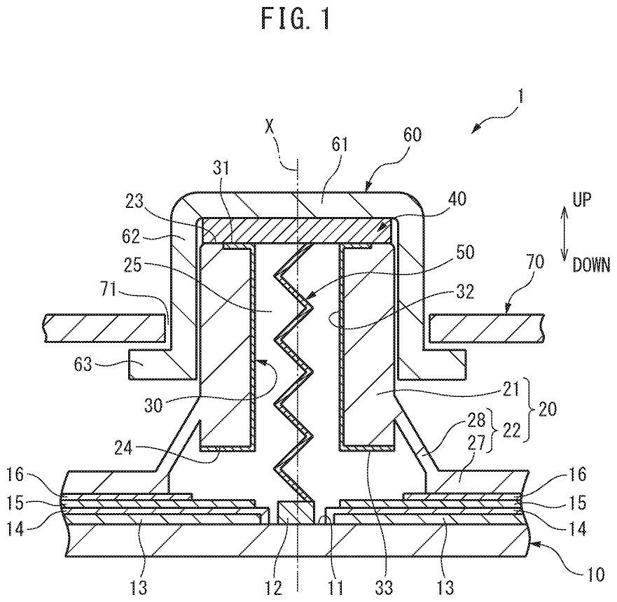

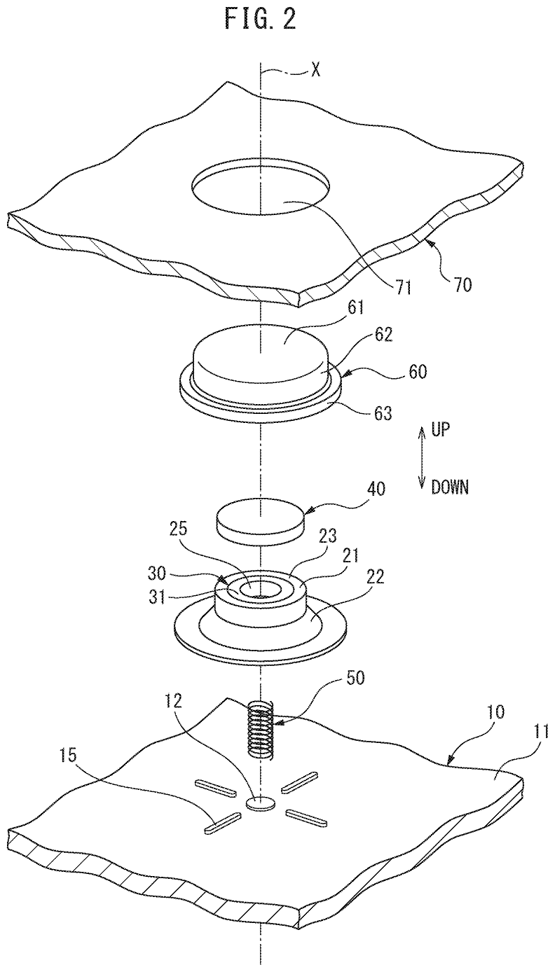

The overall configuration of an input device 1 provided ins a controller according to one embodiment will be described with reference to FIGS. 1 and 2. The controller comprising the input device 1 is configured so as to output signals in response to operations by a user. In particular, in the example embodiment, the controller is configured so as to be capable of detecting the presence or absence of depression of the keycap of the input device 1 by the user equal to or greater than a reference amount, a degree to which an object operating the input device 1 (for example, a finger of the user, which is a person) approaches the keycap when the finger of the user is approaching the keycap, and a depression amount of the keycap.

FIG. 1 is a cross-sectional view of the input device 1 taken along an axis line X of the input device 1. FIG. 2 is an exploded perspective view of the input device 1. As shown in FIGS. 1 and 2, the input device 1 comprises a substrate 10, an elastic member 20, a conductive layer 30, a conductive plate 40, a coil spring 50, a keycap 60, and a cover 70. As shown in FIGS. 1 and 2, the elastic member 20, the conductive plate 40, the coil spring 50, and the keycap 60 are arranged so as to overlap each other such that the centers thereof are positioned on the axis line X.

In the present description, the direction from the substrate 10 to the keycap 60 along the axis line X is referred to as “up,” and the direction from the keycap 60 to the substrate 10 (i.e., the direction opposite to “up”) is referred to as “down.” Note that “up” and “down” are used for convenience of explanation, the input device 1 need not necessarily be used such that “up” corresponds to the vertically upward direction, and the input device 1 can be used in any orientation. Thus, the input device 1 can be used such that, for example, the axis line X extends horizontally, or such that the axis line X extends in various different directions during use. Therefore, “up” can be considered a first direction, and “down” can be considered a second direction which is opposite to the first direction. Since the keycap 60 moves along the axis line X when depressed by the user, the up and down directions are the movement directions of the keycap 60, and the downward direction is the direction in which the user depresses the keycap 60.

In the present description, the direction radially away from axis line X perpendicular to the axis line X is referred to as outward, and the direction perpendicular to axis line X toward axis line X (i.e., the direction opposite to outward) is referred to as inward. In the present description, the state in which no external forces are applied to input device 1 by the finger of the user or the like is referred to as the natural state.

### Substrate

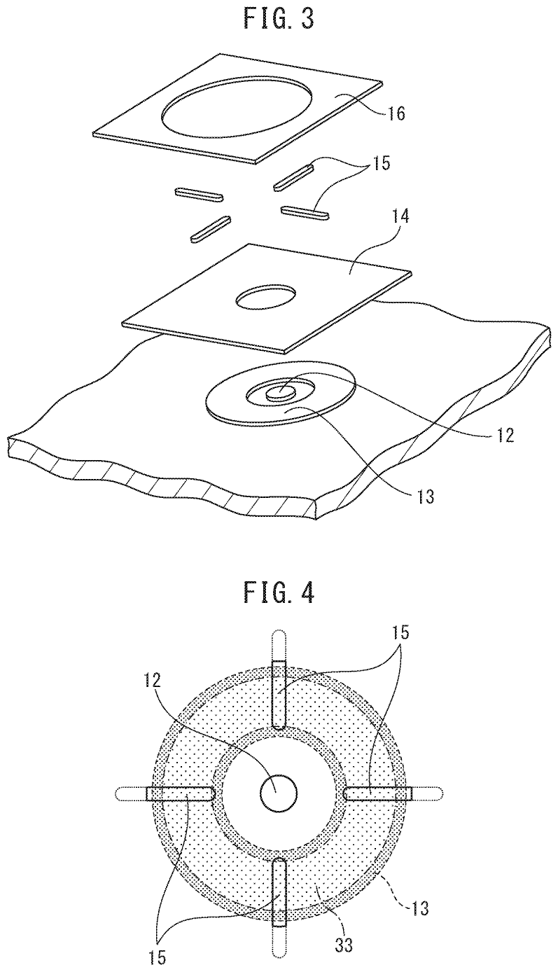

Next, the substrate 10 will be described with reference to FIGS. 1 to 4. FIG. 3 is an exploded perspective view of part of the substrate 10. FIG. 4 is a plan view of the substrate 10. In particular, FIG. 4 shows the positional relationship between a central electrode 12, a ground electrode 13, a high potential electrode 15, and a moving electrode 33 (all of which will be described later) as viewed from above in the direction of the axis line X. The substrate 10 is a plate-like member on which electronic components are arranged. The substrate 10 is, for example, a printed circuit board. The substrate 10 may be a rigid substrate or an FPC. The substrate 10 has a substrate upper surface 11 provided on the upper side thereof.

In the example embodiment, as shown in FIGS. 1 to 4, one central electrode 12, ground electrode 13, first insulation layer 14, high potential electrode 15, and second insulation layer 16 are provided on the substrate upper surface 11.

The central electrode 12 is formed in a circular shape and is arranged such that the center thereof is positioned on the axis line X. Note that the central electrode 12 may be formed in a shape other than a circle, or may be arranged shifted from the axis line X. However, the central electrode 12 is formed in a shape and arranged so that it can come into contact with the coil spring 50.

The ground electrode 13 is an example of a second electrode connected to ground. In the example embodiment, as shown in FIG. 4, the ground electrode 13 is formed in an annular shape at a distance from the central electrode 12 so as to surround the central electrode 12, and is arranged such that the center thereof is positioned on the axis line X. As shown in FIGS. 1 and 3, the entirety of the upper surface of the ground electrode 13 is covered by the first insulation layer 14. The first insulation layer 14 is formed from, for example, a prepreg. Since the substrate upper surface 11 is also formed from an insulator, the entirety of the ground electrode 13 is surrounded by the insulator.

In the example embodiment, as shown in 4, the ground electrode 13 is configured so as to overlap the entirety of the moving electrode 33 provided on the lower surface of the movable part 21 of the elastic member 20 when viewed in the direction of the axis line X. Thus, the ground electrode 13 is formed such that the upper surface thereof has a surface area greater than that of the lower surface of the moving electrode 33. Note that the ground electrode 13 need not necessarily overlap the entirety of the moving electrode 33 as long as it overlaps part of the moving electrode 33 when viewed in the direction of the axis line X. The ground electrode 13 is arranged opposite the moving electrode 33 so that the capacitance between the ground electrode 13 and the moving electrode 33 changes in accordance with the distance therebetween.

Note that in the example embodiment, the ground electrode 13 is formed in an annular shape. However, the ground electrode 13 may be formed in a shape other than an annular shape as long as it is formed so as to surround the central electrode 12. Furthermore, though the ground electrode 13 is formed in a continuous annular shape so as to surround the entirety of the central electrode 12, it may also be formed in annular shapes that are partially spaced apart in the circumferential direction.

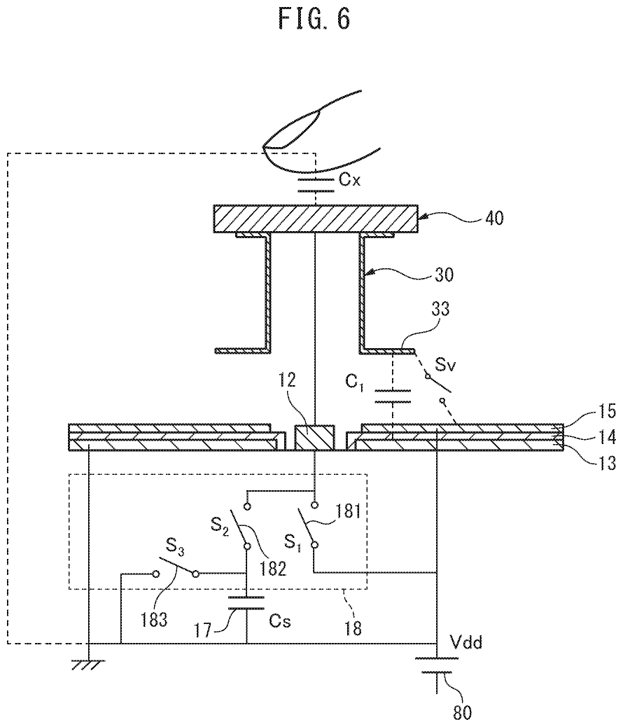

The high potential electrode 15 is an example of a third electrode connected to a power supply 80 (FIG. 6) having a higher potential than ground. As shown in FIGS. 1 to 4, the high potential electrode 15 is formed in the shape of lines extending radially from the axis line X. In the example embodiment, the high potential electrode 15 is formed in four lines centered on the axis line X. The high potential electrode 15 is arranged on the first insulation layer 14 and is arranged so as to overlap the ground electrode 13 when viewed in the direction of the axis line X. Thus, the ground electrode 13 and the high potential electrode 15 are arranged so as to face each other with the first insulation layer 14 interposed therebetween. Since the first insulation layer 14 is provided between the ground electrode 13 and the high potential electrode 15, contact between the high potential electrode 15 and the ground electrode 13 and direct current flow is suppressed.

Furthermore, as shown in FIGS. 1 and 3, part of the high potential electrode 15 is covered by the second insulation layer 16. In the example embodiment, a region of the high potential electrode 15 distant from the axis line X is covered by the second insulation layer 16. In particular, in the example embodiment, as shown in FIG. 4, part of the high potential electrode 15 which does not overlap with the moving electrode 33 when viewed in the direction of the axis line X is covered by the second insulation layer 16. The second insulation layer 16 is formed from, for example, a solder resist. Note that the second insulation layer 16 need not necessarily be provided. Thus, the high potential electrode 15 may be arranged such that the entirety of the upper surface thereof is exposed to the outside.

Note that in the example embodiment, the high potential electrode 15 is four thin linear electrodes extending radially. However, the high potential electrode 15 may be a single linear electrode, or may be a plurality of linear electrodes other than four. Alternatively, the high potential electrode 15 may be one or a plurality of point-like electrodes. In any case, the high potential electrode 15 may be an electrode of any configuration as long as it can contact the moving electrode 33 so as to be electrically conductive without causing contact failure when the moving electrode 33 moves downward. However, in the example embodiment, the high potential electrode 15 is formed such that the area overlapping the moving electrode 33 when viewed in the axis line X direction is sufficiently smaller than the area overlapping between the ground electrode 13 and the moving electrode 33. In other words, in the example embodiment, the surface area of the ground electrode 13 facing the moving electrode 33 is greater than the surface area of the high potential electrode 15 facing the moving electrode 33.

In the example embodiment, the central electrode 12, the ground electrode 13, the first insulation layer 14, the high potential electrode 15, and the second insulation layer 16 are formed on the substrate upper surface 11 of the substrate 10. However, at least some of these may be formed embedded in the substrate 10. Thus, for example, the ground electrode 13 and the first insulation layer 14 may be formed embedded in the substrate 10, and the central electrode 12, the high potential electrode 15, and the second insulation layer 16 may be formed on the substrate upper surface 11, with the central electrode 12 and the high potential electrode 15 exposed on the surface of the substrate 10. By forming some of the constituent elements embedded in the substrate 10 in this manner, production of the substrate 10 having the electrodes and insulation layers described above is facilitated.

### Elastic Member

Next, the elastic member 20 will be described with reference to FIGS. 1 and 2. The elastic member 20 is formed of a non-conductive elastic material, for example, a synthetic rubber such as silicone rubber. The elastic member 20 is arranged on the upper side of the substrate 10. In particular, in the example embodiment, the elastic member 20 is arranged on the second insulation layer 16 on the substrate 10. Furthermore, the elastic member 20 is arranged such that the axis line thereof is positioned on the axis line X of the input device 1.

The elastic member 20 comprises a movable part 21 which moves in the up and down directions, and a biasing part 22 which is connected to the movable part 21. In the example embodiment, the inner periphery of the biasing part 22 is connected to the outer periphery of the movable part 21. Though the movable part 21 and the biasing part 22 are integrally formed in the example embodiment, they may also be formed as separate components. In this case, the movable part 21 and the biasing part 22 may be formed of different materials, for example, the movable part 21 may be formed of a material different from the elastic body.

The movable part 21 is arranged below the keycap 60, and is a component which moves in the axis line X direction, and specifically, the up and down directions, when the input device 1 (particularly the keycap 60) is depressed by an object such as a finger of the user. In particular, the movable part 21 is positioned at the uppermost position within its movable range when in the natural state. The movable part 21 can move downward until the moving electrode 33, which is arranged below the movable part 21 and moves together with the movable part 21, comes into contact with the substrate 10, and in particular, the high potential electrode 15 on the substrate 10.

The movable part 21 has a movable part upper surface 23 provided on the upper side thereof, a movable part lower surface 24 provided on the lower side thereof, and a through hole 25 extending through the movable part 21 in the up and down directions between the movable part upper surface 23 and the movable part lower surface 24. Thus, the movable part 21 is formed in a hollow cylindrical shape. In the example embodiment, the through hole 25 is formed such that the axis line thereof is positioned on the axis line X of the input device 1. Furthermore, in the example embodiment, the movable part 21 is formed so as to be solid except for the through hole 25. Note that the movable part 21 may have a shape other than a cylindrical shape as long as it is formed in a hollow tubular shape.

The biasing part 22 biases the movable part 21 toward a position in the natural state when the movable part 21 moves downward from the natural state. The biasing part 22 comprises a base part 27 arranged on the substrate upper surface 11, and in particular, on the second insulation layer 16, and a skirt part 28 extending between the movable part 21 and the base part 27.

The base part 27 is arranged so as to be immobile on the second insulation layer 16. In particular, in the example embodiment, the base part 27 is interposed between the substrate 10 and an attachment member (not illustrated) of the cover 70, and is affixed onto the second insulation layer 16 by the substrate 10 and the attachment member so as to be immobile. Note that this affixation method is merely exemplary, and any appropriate method can be adopted.

The skirt part 28 is a plate-like member having a truncated conical shape, the upper circular edge thereof is connected to the outer periphery of the movable part 21, and the lower circular edge thereof is connected to the base part 27. The skirt part 28 deforms when the movable part 21 moves downward from the natural state, and the elastic force thereof biases the movable part 21 upward.

### Conductive Layer

As shown in FIG. 1, the conductive layer 30 is provided on the movable part upper surface 23, the movable part lower surface 24, and the inner surface of the movable part 21 facing the through hole 25. The conductive layer 30 comprises an upper conductive layer 31 provided on the movable part upper surface 23, a connecting conductive layer 32 provided on the movable part inner surface, and a moving electrode 33 provided on the movable part lower surface 24. The moving electrode 33 is arranged on the movable part lower surface 24 of the movable part 21, which is on the side opposite from the keycap 60 side (i.e., the movable part upper surface 23). In the example embodiment, the upper conductive layer 31 and the moving electrode 33 are formed in an annular shape, and the connecting conductive layer 32 is formed in a cylindrical shape. In the example embodiment, the upper conductive layer 31 is arranged so as to extend over part of the movable part upper surface 23. The moving electrode 33 is arranged so as to extend over the entirety of the movable part lower surface 24. As a result, the surface area of the surface of the moving electrode 33 facing the ground electrode 13 can be maximized. The upper conductive layer 31 is electrically connected to the moving electrode 33 via the connecting conductive layer 32.

The upper conductive layer 31 may be formed in a shape other than an annular shape, and may be arranged so as to extend over the entire movable part upper surface 23. The moving electrode 33 may be formed in a shape other than an annular shape, and may be arranged so as to extend over part of the movable part lower surface 24. However, the moving electrode 33 is arranged so as to contact the high potential electrode 15 when the movable part 21 moves downward, and specifically, to at least partially overlap the high potential electrode 15 when viewed in the direction of the axis line X. Thus, the high potential electrode 15 is arranged so as to contact the moving electrode 33 when the downward movement amount of the movable part 21 becomes equal to or greater than a specified amount, i.e., when the depression amount of the keycap 60 becomes equal to or greater than a specified reference amount. Additionally, the connecting conductive layer 32 may be formed in any manner as long as it can electrically connect the upper conductive layer 31 to the moving electrode 33.

In the example embodiment, the conductive layer 30 is a conductive coating affixed to the surface of the movable part 21, for example, carbon ink sintered on the surface of the movable part 21. Thus, the conductive layer 30 is formed of a deformable material (a flexible material). As a result, when the moving electrode 33 contacts the high potential electrode 15, it deforms to fit the shape of the high potential electrode 15, thereby increasing the contact area with the high potential electrode 15. Furthermore, since the conductive layer 30 is formed of sintering carbon ink, it is easy to form the conductive layer 30. However, the conductive layer 30 may be formed of a material other than a conductive coating (for example, a metal) as long as it is conductive, or may be formed of a material that is not flexible.

The moving electrode 33 arranged on the movable part lower surface 24 is arranged so as to be spaced from the substrate upper surface 11 in the natural state and to face the substrate upper surface 11. In particular, in the example embodiment, the moving electrode 33 is arranged so as to be parallel to the substrate upper surface 11 in the natural state.

Furthermore, as shown in FIG. 1, the moving electrode 33 arranged on the movable part lower surface 24 moves in response to the movement of the movable part 21. In particular, since the movable part 21 moves in the direction of the axis line X in accordance with depression of the keycap 60 by the user, the moving electrode 33 moves in the direction of the axis line X in response to depression of the keycap 60. Thus, the moving electrode 33 is an example of a first electrode which moves in the direction of the axis line X.

In the example embodiment, the conductive layer 30 is formed on the surface of the movable part 21. However, the elastic member 20 may be formed from a conductive material. In this case, it is not necessary that the conductive layer 30 be formed on the surface of the movable part 21. In this case, the elastic member 20 and the conductive plate 40 may be integrally formed from a conductive material.

### Conductive Plate

Next, the conductive plate 40 will be described with reference to FIGS. 1 and 2. The conductive plate 40 is an example of a fourth electrode which is arranged adjacent to the depressed surface of the keycap 60 and which is electrically connected with the moving electrode 33. The conductive plate 40 is used for detecting the degree to which a grounded conductor, such as a finger of the user, approaches the keycap 60. The conductive plate 40 is configured such that when a grounded conductor, such as a finger of the user, approaches, the capacitance between the conductor and the conductive plate 40 changes. As a result, the degree to which the finger of the user, etc., approaches the keycap 60 can be detected, as will be described later.

The conductive plate 40 is formed of a conductive material, for example, a metal such as stainless steel. Alternatively, the conductive plate 40 may be formed by providing a conductive coating on a non-conductive material such as resin, or by providing a non-conductive material on a conductive material. The conductive plate 40 is also more rigid than other components, in particular, the elastic member 20. In particular, the conductive plate 40 has rigidity sufficient to prevent deformation even when the keycap 60 is depressed by a finger of the user or the like.

The conductive plate 40 is arranged such that the axis line thereof is positioned on the axis line X of the input device 1. In the example embodiment, the conductive plate 40 is formed in a disk shape. The conductive plate 40 has a circular shape that is substantially the same as the shape (circular shape) of the movable part upper surface 23. Thus, the conductive plate 40 is formed so as to cover the entirety of the movable part upper surface 23. As a result, the surface area of the upper surface of the conductive plate 40 can be maximized, facilitating detection of the approach of a finger of the user or the like to the keycap 60. Note that the conductive plate 40 may be formed so as to cover the entirety of the movable part upper surface 23 and so as to protrude radially outward from the movable part upper surface 23. Alternatively, the conductive plate 40 may be formed so as to cover the movable part upper surface 23 but be smaller than the movable part upper surface 23.

Furthermore, the conductive plate 40 is adhered to the movable part upper surface 23 of the elastic member 20 and the upper conductive layer 31 provided on the movable part upper surface 23 by a conductive adhesive. Thus, the conductive plate 40 is provided so as to be electrically connected to the upper conductive layer 31, and therefore, to be electrically connected to the moving electrode 33.

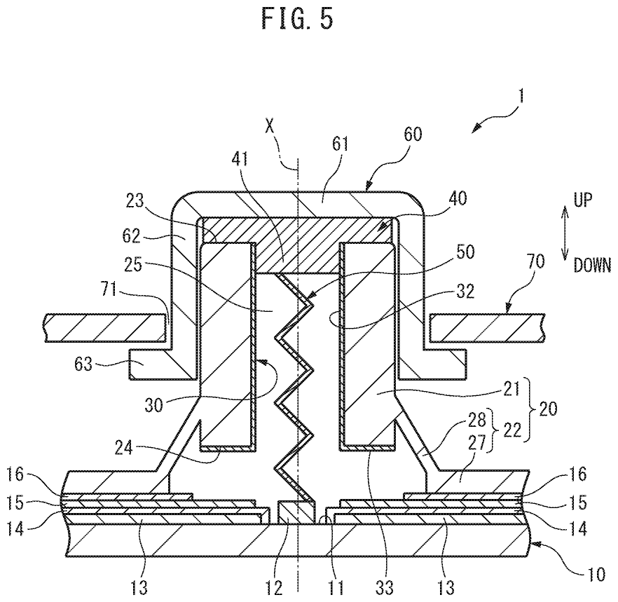

Note that the conductive plate 40 may have a cylindrical protrusion 41 protruding downward from the lower surface, as shown in FIG. 5, which illustrates a modification example of the input device 1. This protrusion 41 may have a shape complementary to part of the through hole 25 provided in the movable part 21, and the conductive plate 40 may be affixed to the movable part 21 by fitting this protrusion 41 into the through hole 25. In this case, adhesive may not be provided between the conductive plate 40 and the movable part upper surface 23 or the upper conductive layer 31. Furthermore, in this case, as shown in FIG. 5, the conductive layer 30 may not comprise an upper conductive layer 31 on the movable part upper surface 23. Thus, in this case, the conductive layer 30 has a connecting conductive layer 32 on the inner surface of the movable part 21 and a moving electrode 33 on the movable part lower surface 24, and the connecting conductive layer 32 extends on the inner surface of the movable part 21 from the movable part lower surface 24 to the movable part upper surface 23. However, the connecting conductive layer 32 provided on the inner surface of the movable part 21 need not extend to the movable part upper surface 23 as long as it can contact the conductive plate 40.

### Coil Spring

The coil spring 50 is arranged such that the axis line thereof is positioned on the axis line X of the input device 1. The coil spring 50 biases the conductive plate 40 upward and establishes electrical continuity between the central electrode 12 and the conductive plate 40. The coil spring 50 is made of a conductive material, for example, a metal such as phosphor bronze.

Furthermore, the coil spring 50 is positioned on the central electrode 12, and the lower end thereof contacts the central electrode 12. In particular, the coil spring 50 is always in contact with the central electrode 12 due to the elastic force of the coil spring 50. Thus, the coil spring 50 is electrically connected to the central electrode 12. Furthermore, when the conductive plate 40 (and keycap 60) is positioned lower than the natural state, the coil spring 50 biases the conductive plate 40 (and keycap 60) upward in the direction away from the substrate 10.

Furthermore, the coil spring 50 is positioned below the conductive plate 40, and the upper end thereof is in contact with the conductive plate 40. In the example embodiment, the conductive plate 40 is always in contact with the coil spring 50 due to the elastic force of the coil spring 50. Thus, the coil spring 50 is electrically connected to the conductive plate 40.

In the example embodiment, the coil spring 50 is formed such that when the conductive plate 40 and the movable part 21 move downward from the natural state, the force with which the coil spring 50 biases the conductive plate 40 upward is less than the force with which the biasing part 22 biases the movable part 21 upward. When the biasing force of the coil spring 50 is greater than the biasing force of the biasing part 22, the conductive plate 40 biased by the coil spring 50 will attempt to move upward faster than the movable part 21 biased by the biasing part 22. As a result, the conductive plate 40 and the movable part 21 may be separated in the vertical direction. In contrast, since the biasing force of the coil spring 50 is less than the biasing force of the biasing part 22 in the example embodiment, the conductive plate 40 and the movable part 21 are prevented from being separated in the vertical direction.

Note that the coil spring 50 may be connected to the central electrode 12 or the conductive plate 40 by, for example, solder. Alternatively, another elastic member may be used in place of the coil spring 50. Such other elastic member may be any member which is conductive and which provides electrical connection between the central electrode 12 and the conductive plate 40 and biases the conductive plate 40 upward. Alternatively, a member which does not bias the conductive plate 40 upward, such as a conductive wire, may be used in place of the coil spring 50, as long as it can provide electrical connection between the central electrode 12 and the conductive plate 40.

### Keycap

The keycap 60 is the member of the input device 1 that is directly depressed by the user. The keycap 60 is made of a non-conductive material, for example, a resin such as polyacetal. The keycap 60 is provided above the elastic member 20 comprising the movable part 21 and the conductive plate 40. The keycap 60 is arranged such that the axis line thereof is positioned on the axis line X of the input device 1.

The keycap 60 is adhered to the upper surface of the conductive plate 40 by an adhesive. As a result, the keycap 60 moves integrally with the conductive plate 40. Since the conductive plate 40 is adhered to the movable part 21 and the conductive layer 30 is affixed to the surface of the movable part 21, the keycap 60, the conductive plate 40, the movable part 21, and the conductive layer 30 move integrally. In the example embodiment, a non-conductive adhesive is used as the adhesive for adhering the keycap 60 to the conductive plate 40. Note that the keycap 60 need not be adhered to the conductive plate 40.

The keycap 60 has a circular top wall 61, a cylindrical side wall 62, and a flange 63. The top end of the cylindrical side wall 62 is connected to the outer periphery of the top wall 61. The flange 63 extends outward from the bottom end of the side wall 62.

The keycap 60 is arranged such that the side wall 62 is positioned within an opening 71 formed in the cover 70. The outer diameter of the side wall 62 is less than the outer diameter of the opening 71. Thus, the keycap 60 can move up and down within the opening 71. The flange 63 is formed such that the outer diameter thereof is greater than the outer diameter of the opening 71. As a result, the flange 63 cannot move upward beyond the opening 71. Therefore, even if the movable part 21 and the conductive plate 40 are biased upward and the keycap 60 is biased upward accordingly, the keycap 60 cannot move upward beyond the state in which the flange 63 contacts the lower surface of the cover 70. In the example embodiment, the state in which the keycap 60 is biased upward and the flange 63 contacts the lower surface of the cover 70 is the natural state.

### Cover

The cover 70 constitutes part of a housing in which the components of the input device 1 are housed. The cover 70 is made of a material such as resin, and comprises an opening 71 through which the keycap 60 moves.

### Circuit Configuration

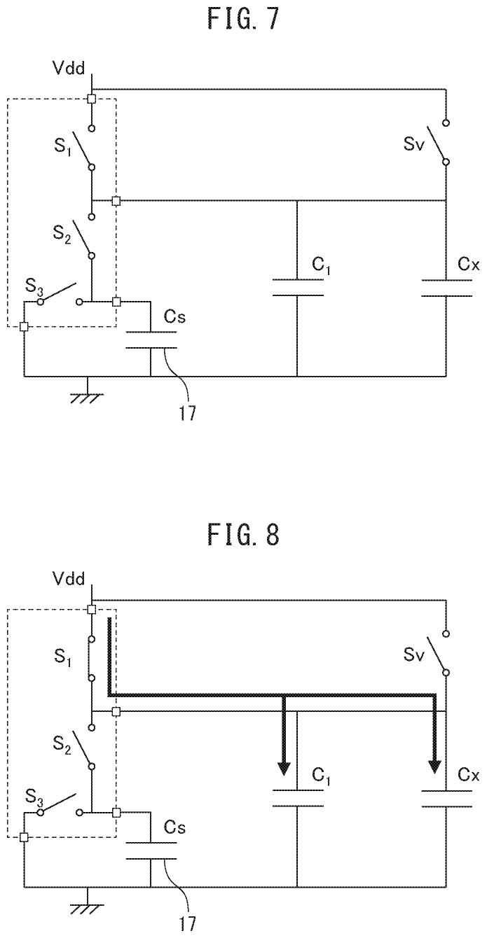

Next, the circuit configuration of the input device 1 will be described with reference to FIGS. 6 and 7. FIG. 6 is a view conceptually showing the relationship between the actual configuration of the input device 1 and the circuit, and FIG. 7 is a view showing the circuit configuration of the input device 1.

As shown in FIGS. 6 and 7, the input device 1 is connected to a power supply 80 and uses power supplied from the power supply 80 to detect whether the keycap 60 has been depressed equal to or greater than a reference amount, the degree to which a finger is approaching the keycap 60, and the depression amount of the keycap 60. The input device 1 comprises a chargeable capacitor 17 having a capacitance Cs, and a control and detection circuit 18 for controlling the input device 1 and detecting the amount of charge (hereinafter referred to as the “charge amount”) stored in the capacitor 17. The control and detection circuit 18 functions as a switching part comprising a plurality of switches, and a sensor part for detecting the charge amount of the capacitor 17.

As shown in FIGS. 6 and 7, the ground electrode 13 and the capacitor 17 are connected to ground. The high potential electrode 15 is connected to the power supply 80. Thus, a specified voltage Vdd is always applied to the high potential electrode 15 with respect to ground. The control and detection circuit 18 is also connected to the power supply 80.

The control and detection circuit 18 comprises a plurality of switching elements 181 to 183 which can quickly switch on and off connection.

The first switching element 181 among these switching elements functions as a first switch S₁ for turning on and off the connection between the power supply 80 and the central electrode 12. When the first switch S₁ constituted by the first switching element 181 is turned on, the power supply 80 and the central electrode 12 are brought into electrical connection, and the specified voltage Vdd is applied to the central electrode 12. At this time, the central electrode 12 is connected to the same power supply as the power supply 80 connected to the high potential electrode 15. Thus, the voltage Vdd applied to the central electrode 12 is the same as the voltage Vdd applied to the high potential electrode 15. As a result, the need to prepare different power supplies for the high potential electrode 15 and the central electrode 12 can be eliminated, simplifying the power supply configuration. Note that the high potential electrode 15 and the central electrode 12 may be connected to different power supplies so as to have different potentials.

Since the central electrode 12 is connected to the conductive plate 40 and the moving electrode 33 of the conductive layer 30 via the coil spring 50 and the conductive layer 30, when the first switch S₁ is turned on, the power supply 80 is brought into electrical connection with the conductive plate 40 and the moving electrode 33, and a specified voltage is applied to the conductive plate 40 and the moving electrode 33 with respect to ground. In the example embodiment, the voltage applied to the conductive plate 40 and the moving electrode 33 at this time is equal to the voltage applied to the high potential electrode 15, but it may be different. Conversely, when the first switch S₁ is turned off, the power supply 80 and the central electrode 12 are not electrically connected, and therefore, no voltage is applied to the conductive plate 40 and the moving electrode 33.

The second switching element 182 also functions as a second switch S₂ for turning on and off connection between the central electrode 12 and the capacitor 17. When the second switch S₂ constituted by the second switching element 182 is turned on, the central electrode 12 and the capacitor 17 are brought into electrical connection, and thus, the conductive plate 40 and the moving electrode 33 are electrically connected to the capacitor 17. As will be described later, when charge is stored in the moving electrode 33 due to the capacitance C₁ between the moving electrode 33 and the ground electrode 13, or when charge is stored in the conductive plate 40 due to capacitance Cx between a conductor such as the hand of the user and the conductive plate 40, if the second switch S₂ is turned on, the stored charge moves to the capacitor 17, and the capacitor 17 is charged. Conversely, when the second switch S₂ is turned off, there is no electrical connection between the conductive plate 40 and the moving electrode 33 and the capacitor 17. Thus, even if charge is stored in the conductive plate 40 and the moving electrode 33, the stored charge does not move to the capacitor 17.

In the example embodiment, the control and detection circuit 18 is switchable between a first state in which the first switch S₁ is turned on and the second switch S₂ is turned off, and a second state in which the first switch S₁ is turned off and the second switch S₂ is turned on. Specifically, the control and detection circuit 18 is switchable between the first state in which the power supply 80 is connected to the conductive plate 40 and the moving electrode 33, and the conductive plate 40 and the moving electrode 33 are not connected to the capacitor 17, and the second state in which the power supply 80 is not connected to the conductive plate 40 and the moving electrode 33, and the conductive plate 40 and the moving electrode 33 are connected to the capacitor 17.

The third switching element 183 functions as a third switch S₃ for turning on and off connection between the terminal of the capacitor 17 opposite the ground side and ground. When the third switch S₃ constituted by the third switching element 183 is turned on, the terminal of the capacitor 17 opposite the ground side is connected to ground, and thus, both terminals of the capacitor 17 are connected to ground. As a result, if charge has been stored in the capacitor 17, the stored charge is discharged. Conversely, when the third switch S₃ is turned off, the terminal of the capacitor 17 opposite the ground side is not connected to ground, and thus, the charge stored in the capacitor 17 is not discharged.

FIGS. 6 and 7 also depict a virtual switch Sv between the moving electrode 33 and the high potential electrode 15. Though the moving electrode 33 does not contact the high potential electrode 15 in the natural state, as described above, when the movable part 21 moves downward, it comes into contact with the high potential electrode 15. Thus, as the movable part 21 moves, the connection between the moving electrode 33 and the high potential electrode 15 is switched on and off. In FIGS. 6 and 7, since the connection can be switched on and off in this manner, it is depicted as a virtual switch Sv.

### Basic Operations

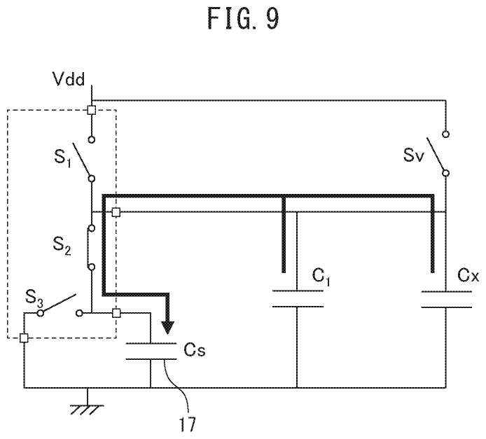

Next, the basic operations of the input device 1 having the circuit configuration described above will be described with reference to FIGS. 8 and 9. In the input device 1, it is detected whether the keycap 60 is depressed by equal to or greater than the reference amount, the degree to which a finger approaches the keycap 60, and the depression amount of the keycap 60 by the basic operations. Specifically, in the input device 1, the capacitance C₁ between the moving electrode 33 and the ground electrode 13, and the capacitance Cx between a conductor such as the hand of the user and the conductive plate 40 are detected by the basic operations. In particular, in the example embodiment, capacitance is detected by a charge transfer method.

FIG. 8 shows the flow of positive charge in the first state in which the first switch S₁ is turned on and the second switch S₂ is turned off, and FIG. 9 shows the flow of positive charge in the second state in which the first switch S₁ is turned off and the second switch S₂ is turned on.

In the basic operations, first, the first switch S₁ is turned off, and the second switch S₂ and third switch S₃ are turned on. As a result, the central electrode 12 is connected to ground, and thus, the moving electrode 33 and conductive plate 40 are connected to ground. Thus, the positive charge stored in the moving electrode 33 and the conductive plate 40 is discharged. Furthermore, the terminal of the capacitor 17 opposite to the ground side is connected to ground, and the charge stored in the capacitor 17 is also discharged.

Thereafter, the first switch S₁, the second switch S₂, and the third switch S₃ are all turned off once, and then, as shown in FIG. 8, the first switch S₁ is turned on and the second switch S₂ is turned off. As a result, positive charge moves from the power supply 80 to the moving electrode 33 and the conductive plate 40, as indicated by the arrows in FIG. 8. At this time, the amount of positive charge moved to the moving electrode 33 and the conductive plate 40 changes in accordance with the capacitance C₁ between the moving electrode 33 and the ground electrode 13, and the capacitance Cx between a conductor such as the hand of the user and the conductive plate 40, respectively. The greater the capacitances C₁, Cx, the greater the amount of positive charge moved to the moving electrode 33 and the conductive plate 40.

Thereafter, the first switch S₁, the second switch S₂, and the third switch S₃ are all turned off again, and then, as shown in FIG. 9, the first switch S₁ is turned off and the second switch S₂ is turned on. As a result, the positive charge stored in the moving electrode 33 and the conductive plate 40 moves to the capacitor 17, as indicated by the arrows in FIG. 9. The positive charge stored in the moving electrode 33 and the conductive plate 40 in the first state shown in FIG. 8 moves to the capacitor 17. Thus, the amount of positive charge newly stored in the capacitor 17 at this time is proportional to the capacitance C₁ between the moving electrode 33 and the ground electrode 13 and the capacitance Cx between a conductor such as the hand of the user and the conductive plate 40.

Thereafter, the first switch S₁, the second switch S₂, and the third switch S₃ are all turned off again, and the potential of the capacitor 17 is detected by the control and detection circuit 18. The potential of the capacitor 17 at this time is proportional to the charge stored in the capacitor 17. Therefore, the potential of the capacitor 17 represents the charge that has been stored in the capacitor 17 up to that point.

Thereafter, the switches S₁, S₂, S₃ are switched again to the first state shown in FIG. 8. Then, the switches S₁, S₂, S₃ are repeatedly switched between the first state shown in FIG. 8 and the second state shown in FIG. 9 as described above.

When the switches S₁, S₂, S₃ are repeatedly switched between the first state shown in FIG. 8 and the second state shown in FIG. 9 in this manner, the charge stored in the capacitor 17 gradually increases. In the example embodiment, the degree to which the finger is approaching the keycap 60 and the depression amount of the keycap 60 are detected based on the potential of the capacitor 17 detected after the charge has been cumulatively stored in the capacitor 17 in this manner.

In the example embodiment, the switches S₁, S₂, S₃ are repeatedly switched until the potential of the capacitor 17 detected by the control and detection circuit 18 reaches a specified reference value, and specifically, until the charge amount of the capacitor 17 reaches a specified charge amount. The greater the capacitance C₁ between the moving electrode 33 and the ground electrode 13, and the greater the capacitance Cx between a conductor such as the hand of the user and the conductive plate 40, the faster the charge is stored in the capacitor 17. Thus, the greater these capacitances C₁, Cx, the fewer the number of repetitions of switching until the potential of the capacitor 17 reaches the specified reference value. Alternatively, the greater these capacitances C₁, Cx, the shorter the time it takes for the potential of the capacitor 17 to reach the specified reference value. Thus, in the example embodiment, the degree to which the finger is approaching the keycap 60 and the depression amount of the keycap 60 are detected based on the switch count of times or the time it takes for the potential of the capacitor 17 to reach the reference value.

The capacitance C₁ between the moving electrode 33 and the ground electrode 13 and the capacitance Cx between a conductor such as the hand of the user and the conductive plate 40 are relatively small. Thus, when the switches S₁, S₂, S₃ are switched between the first state and the second state only once, the charge amount of the capacitor 17 is small. Therefore, when the depression amount of the keycap 60, etc., is detected based on the charge amount at this time, noise is significant. Conversely, in the example embodiment, such noise can be reduced by detecting the depression amount of the keycap 60, etc., based on switch count of times until the potential of the capacitor 17 reaches the reference value.

Note that in the example embodiment, the degree to which the finger is approaching the keycap 60 and the amount of depression of the keycap 60 are detected based on the number of repetitions that the switches S₁, S₂, S₃ are repeatedly switched between the first state and the second state until the potential of the capacitor 17 reaches the specified reference value, and specifically, until the charge amount of the capacitor 17 reaches the specified charge amount. However, the degree to which the finger is approaching the keycap 60 and the amount of depression of the keycap 60 may be detected using other charge parameters which change in accordance with the charge amount of the capacitor 17. For example, the degree to which the finger is approaching the keycap 60 and the amount of depression of the keycap 60 may be detected based on the potential of the capacitor 17 detected by the control and detection circuit 18 after the switching of the switches S₁, S₂, S₃ as described above is repeated a predetermined number of repetitions.

### Operation

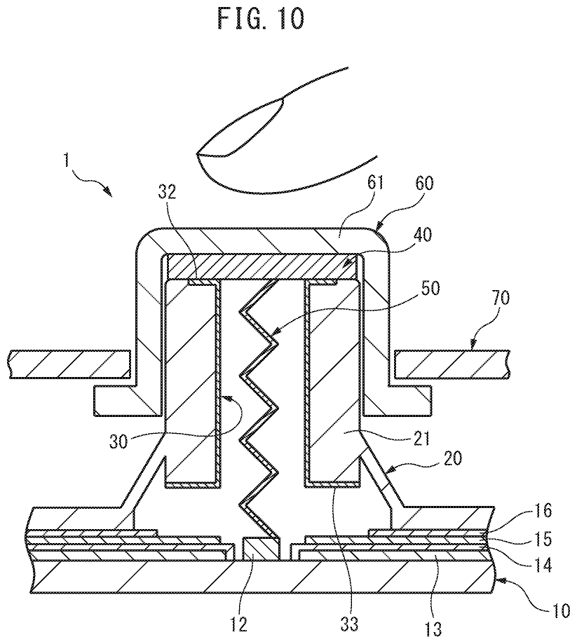

Next, the operation of the input device 1 in response to a depression by the user and the signals output from the input device 1 will be described with reference to FIGS. 10 to 16. FIGS. 10 to 12 show how the keycap 60 is depressed by the finger of the user. FIG. 10 is a cross-sectional view of the input device 1, similar to FIG. 1, when the finger of the user approaches the keycap 60.

As shown in FIG. 10, when a grounded finger of the user approaches the keycap 60, the capacitance Cx is generated between the finger of the user and the conductive plate 40. The capacitance Cx generated between the finger of the user and the conductive plate 40 increases as the finger of the user approaches the keycap 60, and specifically, the closer the finger of the user is to the conductive plate 40. Since the keycap 60 is not depressed down by the finger of the user in the state shown in FIG. 10, the movable part 21 does not move from the natural state. Thus, the distance between the moving electrode 33 and the ground electrode 13 does not change, and the capacitance C₁ therebetween does not change. Therefore, when the finger of the user approaches the keycap 60 as shown in FIG. 10, only the capacitance Cx between the finger of the user and the conductive plate 40 changes in accordance with the distance between the finger of the user and the conductive plate 40; the capacitance C₁ between the moving electrode 33 and the ground electrode 13 does not change.

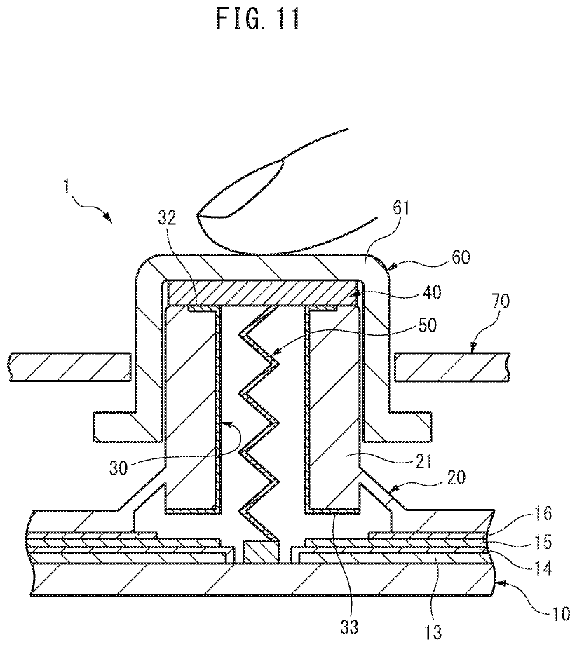

FIG. 11 is a cross-sectional view, similar to FIG. 1, of the input device 1 when the finger of the user is in contact with the keycap 60 and depressing the keycap 60 downward. As shown in FIG. 11, when the finger of the user depresses the keycap 60 downward, the movable part 21 moves downward. Thus, the distance between the moving electrode 33 and the ground electrode 13 is shortened, thereby increasing the capacitance C₁ generated therebetween. Meanwhile, while the finger of the user is depressing the keycap 60 downward, the finger of the user remains in contact with the upper surface of the keycap 60. Thus, the capacitance Cx generated between the finger of the user and the conductive plate 40 does not substantially change. As a result, when the keycap 60 is depressed downward by the finger of the user, only the capacitance C₁ between the moving electrode 33 and the ground electrode 13 changes in accordance with the distance between the moving electrode 33 and the ground electrode 13, and specifically, in accordance with the amount of depression of the keycap 60 by the finger of the user, and the capacitance Cx between the finger of the user and the conductive plate 40 does not substantially change.

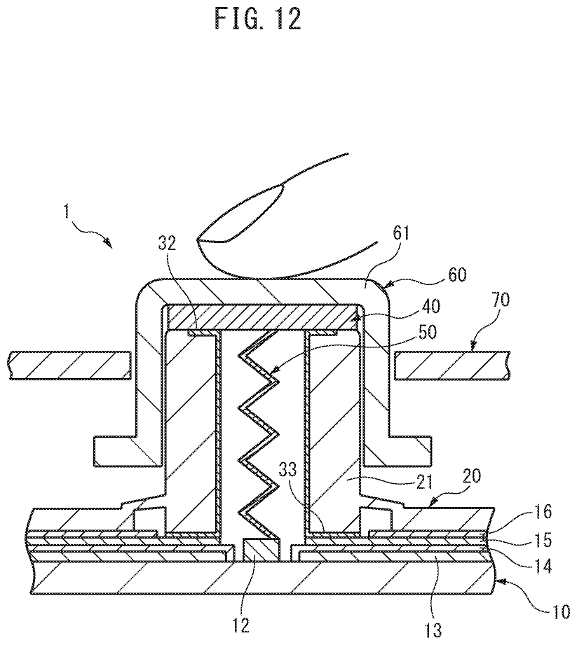

FIG. 12 is a cross-sectional view of the input device 1, similar to FIG. 1, when the movable part 21 moves to the lower limit as a result of depression of the keycap 60 downward by the finger of the user. As shown in FIG. 12, when the depression amount of the keycap 60 exceeds the reference amount and the movable part 21 moves to the lower limit, the moving electrode 33 comes into contact with the high potential electrode 15. As a result, a positive charge can be moved directly from the high potential electrode 15 to the moving electrode 33.

Furthermore, while the keycap 60 is depressed downward and the movable part 21 reaches the lower limit, the finger of the user remains in contact with the upper surface of the keycap 60. Thus, there is substantially no change in the capacitance Cx generated between the finger of the user and the conductive plate 40. Furthermore, since the movable part 21 does not substantially move while it reaches the lower limit, the distance between the moving electrode 33 and the ground electrode 13 does not substantially change, whereby the capacitance C₁ between the moving electrode 33 and the ground electrode 13 does not substantially change.

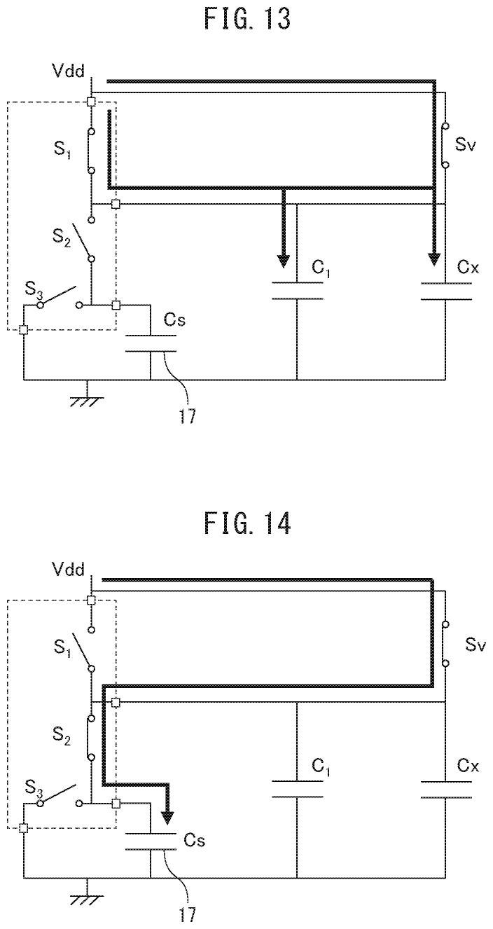

The flow of charge when switching is performed in accordance with the basic operations of the switches S₁ to S₃ in the state in which the movable part 21 has reached the lower limit in this manner as described above will be described. Similar to FIG. 8, FIG. 13 shows the flow of positive charge in the first state in which the first switch S₁ is turned on and the second switch S₂ is turned off. Similar to FIG. 9, FIG. 14 shows the flow of positive charge in the second state in which the first switch S₁ is turned off and the second switch S₂ is turned on. Since the moving electrode 33 is in contact with the high potential electrode 15 in both FIGS. 13 and 14, the virtual switch Sv is on.

Even in a state in which the movable part 21 has reached the lower limit, when the basic operations start, the first switch S₁ is turned off, and the second switch S₂ and the third switch S₃ are turned on. As a result, the charge stored in the moving electrode 33, the conductive plate 40, and the capacitor 17 is discharged.

Thereafter, the switches S₁, S₂, S₃ are all turned off once, and then the first switch S₁ is turned on and the second switch S₂ is turned off (first state) as shown in FIG. 13. At this time, the virtual switch Sv is also turned on. As a result, as indicated by the arrows in FIG. 8, positive charges move from the power supply 80 to the moving electrode 33 and the conductive plate 40, and positive charge corresponding to the capacitances C₁, Cx at this time are stored in the moving electrode 33 and the conductive plate 40.

Thereafter, the switches S₁, S₂, S₃ are all turned off once again, and then the first switch S₁ is turned off and the second switch S₂ is turned on (second state) as shown in FIG. 14. Since the virtual switch Sv is on at this time, the capacitor 17 is directly connected to the power supply 80. Thus, at this time, as indicated by the arrow in FIG. 14, positive charge moves from the power supply 80 to the capacitor 17 until a charge corresponding to the voltage of the power supply 80 is stored in the capacitor 17.

As described above, when the moving electrode 33 is in contact with the high potential electrode 15 (when the virtual switch Sv is on), a greater amount of charge is stored in the capacitor 17 than when the moving electrode 33 is not in contact with the high potential electrode 15 (when the virtual switch Sv is off). Thus, the potential of the capacitor 17 detected by the control and detection circuit 18 reaches the reference value more quickly.

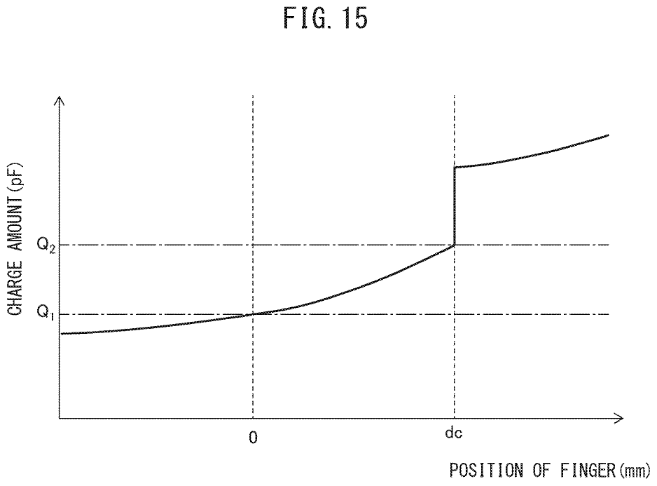

FIG. 15 is a view showing the relationship between the position of the finger of the user, which is the conductor operating the input device 1, and the charge amount of the capacitor 17 when the switches S₁, S₂, S₃ are switched between the first state and the second state a specified number of repetitions. The finger position is represented by zero when the finger is in contact with the keycap 60, and the value of the finger position increases as the finger moves downward. Thus, when the finger is not in contact with the keycap 60 and is separated from the keycap 60, the value of the finger position is negative, and when the finger is in contact with the keycap 60 and depressing the keycap 60, the value of the finger position is positive.

When the input device 1 is in the natural state and the finger of the user is positioned away from the keycap 60, the capacitance Cx generated between the finger of the user and the conductive plate 40 is very small. Furthermore, since the distance between the moving electrode 33 and the ground electrode 13 is large at this time, the capacitance C₁ between the moving electrode 33 and the ground electrode 13 is also small. Thus, the charge amount of the capacitor 17 is small.

When the input device 1 is in the natural state, as the finger of the user approaches the keycap 60 (i.e., as the position of the finger moves to the right toward zero in FIG. 15), the capacitance Cx between the finger of the user and the conductive plate 40 increases. Conversely, the distance between the moving electrode 33 and the ground electrode 13 does not change. Thus, as the finger of the user approaches the keycap 60, the charge amount of the capacitor 17 increases.

As the finger of the user contacts the keycap 60 and depresses the keycap 60 (i.e., as the position of the finger moves from zero to the right in FIG. 15), the distance between the moving electrode 33, which moves integrally with the keycap 60, and the ground electrode 13 gradually decreases. As a result, the capacitance C₁ between the moving electrode 33 and the ground electrode 13 gradually increases. In particular, in the example embodiment, since the ground electrode 13 is configured so as to overlap the entirety of the moving electrode 33 when viewed in the axis line X direction as shown in FIG. 4, the capacitance Cx changes significantly as the distance between the moving electrode 33 and the ground electrode 13 changes. Since the force with which the finger of the user depresses the keycap 60 increases when the keycap 60 is depressed, the finger of the user collapses and the contact area of the finger of the user with the keycap 60 gradually increases, albeit slightly. As a result, as the keycap 60 is depressed, the capacitance Cx between the finger of the user and the conductive plate 40 also increases slightly. Thus, as shown in FIG. 15, as the finger of the user moves downward after contacting the keycap 60, the charge amount of the capacitor 17 increases. At this time, the rate at which the charge amount increases relative to the amount of finger movement is faster than the rate at which the charge amount increases relative to the amount of finger movement when the finger of the user approaches the keycap 60.

Thereafter, when the keycap 60 is further depressed, the depression amount of the keycap 60 reaches the reference amount, and the moving electrode 33, which moves integrally with the keycap 60, comes into contact with the high potential electrode 15 (i.e., when the position of the finger moves to dc in FIG. 15), and the moving electrode 33 comes into contact with the high potential electrode 15. As a result, the moving electrode 33 enters into electrical connection with the high potential electrode 15, and the virtual switch Sv turns on. At this time, the charge amount of the capacitor 17 increases rapidly.

As the keycap 60 is depressed after the moving electrode 33 comes into contact with the high potential electrode 15 (i.e., as the finger position moves from dc to the right in FIG. 15), the contact area between the flexible moving electrode 33 and the high potential electrode 15 increases, improving the contact state between the moving electrode 33 and the high potential electrode 15. Therefore, in the second state shown in FIG. 14, charge can easily be moved from the power supply 80 to the capacitor 17 via the moving electrode 33 and the high potential electrode 15. As a result, as the keycap 60 is depressed after the moving electrode 33 comes into contact with the high potential electrode 15, the charge amount of the capacitor 17 gradually increases.

When the switches S₁, S₂, S₃ are switched between the first state and the second state a specified number of repetitions in this manner, the charge amount of the capacitor 17 changes in accordance with the input state of the input device 1. When the finger of the user, which is a grounded conductor, is approaching the keycap 60 (first input state; state in which the position of the finger is to the left of zero), the charge amount is equal to or less than a first charge amount Q1. When the finger of the user is depressing the keycap 60 with a depression amount less than the reference amount (second input state; state in which the position of the finger is between zero and dc), the charge amount is greater than first charge amount Q1 and less than a second charge amount Q2. When the depression amount of keycap 60 is equal to or greater than the reference amount (third input state; state in which the position of the finger is to the right of dc), the charge amount is equal to or greater than the second charge amount Q2. As a result, the input state of input device 1 can be estimated based on the relationship between the charge amount of the capacitor 17 and the first and second charge amounts Q1, Q2.

Furthermore, in the first input state, the charge amount in the capacitor 17 changes in accordance with the degree to which the finger of the user is approaching the keycap 60. Thus, the degree to which the finger of the user is approaching the keycap 60 in the first input state can be estimated based on the charge amount in the capacitor 17. Furthermore, in the second input state, the charge amount in the capacitor 17 changes in accordance with the degree of depression of the keycap 60. Thus, the degree of depression of the keycap 60 in the second input state can be estimated based on the charge amount in the capacitor 17.

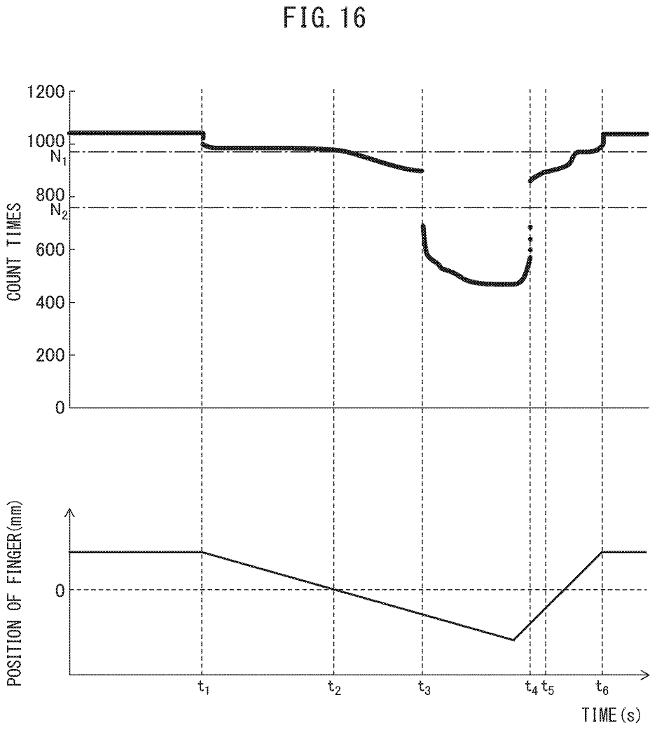

FIG. 16 is a view showing the number of repetitions the switches S₁, S₂, S₃ are switched and the position of the finger of the user over time until the potential of the capacitor 17 reaches the reference value. In the example shown in FIG. 16, the degree to which the finger is approaching the keycap 60 and the amount of depression of the keycap 60 are detected based on the number of repetitions the switches S₁, S₂, S₃ are switched until the potential of the capacitor 17 reaches the reference value.

In the example shown in FIG. 16, the finger of the user gradually approaches the keycap 60 from time t₁, gradually decreasing the number of switching operations. Thereafter, at time t₂, when the finger of the user touches the keycap 60, the number of switching operations reaches N₁ (corresponding to the first charge amount Q1). When the user then depresses the keycap 60, the number of switching operations gradually decreases. The decrease in the number of switching operations relative to the finger movement amount at this time is greater than the decrease in the number of switching operations relative to the finger movement amount before the finger of the user touched the keycap 60. Thereafter, at time t₃, when the depression amount of the keycap 60 reaches the reference amount and the moving electrode 33 comes into contact with the high potential electrode 15, the number of switching operations decreases to equal to or less than N₂. When the user then further depresses the keycap 60, the number of switching operations gradually decreases.

### Information Processing System

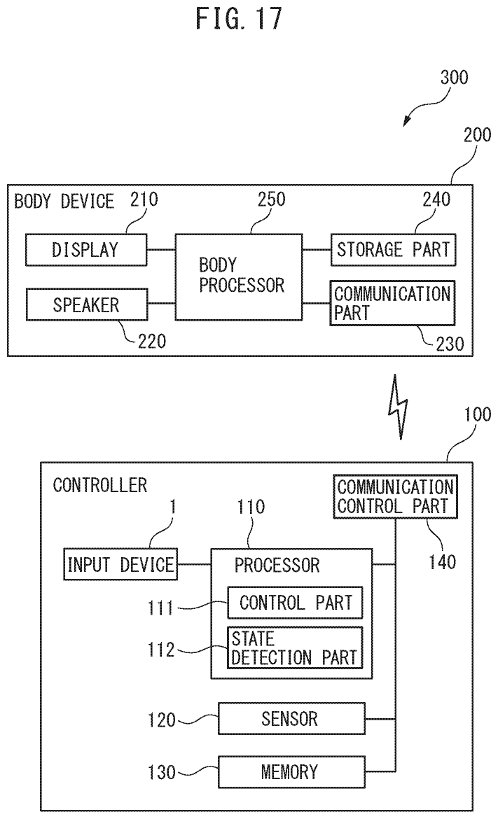

Next, a controller 100 comprising the input device 1 and an information processing system 300 comprising the controller 100 and a body device 200 will be described with reference to FIG. 17. FIG. 17 is a view schematically showing the system configuration of the information processing system 300 comprising the controller 100.

The controller 100 is used to perform various operations associated with information processing. The controller 100 is, for example, a game controller used for operating a game. However, the controller 100 may also be an information processing controller used for performing operations such as moving a cursor and selecting from a menu. As shown in FIG. 17, the controller 100 comprises the input device 1, a processor 110, a sensor 120, a memory 130, and a communication control part 140. The processor 110, the sensor 120, and the memory 130 are all connected to the communication control part 140.

The processor 110 is connected to the control and detection circuit 18 of the input device 1. The voltage of the capacitor 17 detected by the control and detection circuit 18 is input to the processor 110. Furthermore, the processor 110 controls the control and detection circuit 18. As shown in FIG. 17, the processor 110 comprises a control part 111 for controlling the control and detection circuit 18, and a state detection part 112 for detecting the input state of the input device 1 based on the value of the charge parameter detected by the control and detection circuit 18. The control part 111 and the state detection part 112 are functional modules realized by, for example, computer programs executed by the processor 110. Alternatively, the control part 111 and the state detection part 112 may be implemented in the controller 100 as independent integrated circuits, microprocessors, or firmware.

The control part 111 controls the on/off of the switches S₁, S₂, S₃ of the control and detection circuit 18. In particular, the control part 111 controls the switches S₁, S₂, S₃ in accordance with the basic operations described above until the potential of the capacitor 17 reaches the reference value. Meanwhile, the state detection part 112 detects whether the input state of the input device 1 is in the first input state, second input state, or third input state described above, based on the number of repetitions of switching until the potential of the capacitor 17 reaches the reference value. The state detection part 112 detects the degree to which the finger is approaching the keycap 60 and the amount of depression of the keycap 60, based on the number of repetitions of switching until the potential of the capacitor 17 reaches the reference value.

In the example embodiment, the state detection part 112 is provided in the processor 110 of the controller 100. Thus, the functions executed by the state detection part 112 are realized, for example, by a computer program executed by the processor 110. However, the state detection part 112 may also be provided in a body processor 250 of the body device 200, which will be described later. Thus, the functions executed by the state detection part 112 may also be realized, for example, by a computer program executed by the body processor 250.

In the example embodiment, the state detection part 112 determines that the input state is in the first input state when the number of repetitions of switching until the potential of the capacitor 17 reaches the reference value is greater than N₁, determines that the input state is in the second input state when the number of repetitions of switching is equal to or less than N₁ and greater than N₂, and determines that the input state is in the third input state when the number of repetitions of switching is less than or equal to N₂. As a result, the state detection part 112 can detect the input state of the input device 1 based on only one parameter, the number of repetitions of switching.

Furthermore, when the number of repetitions of switching is greater than N₁, the state detection part 112 detects the degree to which the finger is approaching the keycap 60 based on the number of repetitions of switching. Furthermore, when the number of repetitions of switching is between N₁ and N₂, the state detection part 112 detects the depression amount of the keycap 60 based on the number of repetitions of switching. As a result, the state detection part 112 can detect the degree to which the finger is approaching the keycap 60 and the depression amount of the keycap 60 based on only one parameter, the number of repetitions of switching.

The state detection part 112 outputs a signal which changes in accordance with the input state of the input device 1, the degree to which the finger is approaching the keycap 60, and the amount of depression of the keycap 60. The output signal is input to the communication control part 140.

Note that the state detection part 112 may detect the input state of the input device 1, the degree to which the finger is approaching to the keycap 60, and the amount of depression of the keycap 60 based on the value of a charge parameter other than the number of repetitions of switching until the potential of the capacitor 17 reaches the reference value.

The sensor 120 is a sensor for detecting the state of the controller 100. The sensor 120 comprises, for example, an acceleration sensor and an angular velocity sensor. The output signals of these sensors 120 are input to the communication control part 140.

The communication control part 140 communicates with the body device 200 via wireless communication. The communication control part 140 acquires information (for example, information related to the operation of the input device 1 or detection results by the sensor 120) from each input unit (such as the input device 1 or the sensor 120) directly or via the processor 110. Additionally, the communication control part 140 transmits data including the acquired information (or information obtained by performing specified processing on the acquired information) to the body device 200. The communication control part 140 is constituted by, for example, a microprocessor. The communication control part 140 executes various processes by executing firmware stored in the memory 130. Note that the communication control part 140 may communicate with the body device 200 via wired communication in place of or in addition to wireless communication.

As shown in FIG. 17, the body device 200 comprises a display 210, a speaker 220, a communication part 230, a storage part 240, and a body processor 250. The display 210, the speaker 220, the communication part 230, and the storage part 240 are electrically connected to the body processor 250.

The display 210 and the speaker 220 are examples of output devices for outputting information to the user. The display 210 displays images based on commands from the body processor 250. The speaker 220 generates sounds based on commands from the body processor 250.

The communication part 230 is a device for communicating with other devices (for example, the controller 100) via wireless communication. Note that the communication part 230 may be configured so as to be capable of communicating with other devices via wired communication in place of or in addition to wireless communication.

The storage part 240 comprises, for example, a volatile semiconductor memory, a non-volatile semiconductor memory, etc. The storage part 240 may further comprise a storage medium such as a hard disk drive (HDD), a solid state drive (SSD), etc. The storage part 240 stores computer programs executed by the body processor 250 and various data used when the body processor 250 executes various processes.

The body processor 250 comprises one or more central processing units (CPUs) and peripheral circuits therefor. The body processor 250 performs various types of information processing by executing information processing programs stored in the storage part 240. Information processing programs include, for example, an OS program and application programs (for example, game programs).

In particular, in the example embodiment, the body processor 250 performs processing in accordance with information processing programs based on signal outputs from the processor 110 of the controller 100. For example, the body processor 250 may perform processing based on a signal which changes in accordance with the input state output from the processor 110 of the controller 100, the degree to which the finger of the user or the like is approaching the input device 1, or the amount of depression of the input device 1. Thus, the body processor 250 performs processing based on the input state of the input device 1, the degree to which the finger of the user or the like is approaching the input device 1, or the amount of depression of the input device 1.

Further, the body processor 250 outputs the results of processing to output devices such as the display 210 and the speaker 220. Thus, the display 210 and the speaker 220 output the results of the processing performed by the body processor 250 based on the input state of the input device 1, the degree to which the finger of the user or the like is approaching the input device 1, or the amount of depression of the input device 1.

In this manner, the body processor 250 can perform processing based not only on the presence or absence of depression of the input device 1 by the user equal to or greater than the reference amount, but also on the degree to which the finger of the user or the like is approaching the input device 1 and the amount of depression of the input device 1, whereby a wider variety of processing can be performed as compared to the case in which processing is performed based only on the presence or absence of depression of the input device 1 equal to or greater than the reference amount.

Note that in the example embodiment, the body device 200 comprises output devices such as a display and a speaker, and the results of processing by the body processor 250 of the body device 200 are output from these output devices. However, the body device 200 may output the results of processing to an external output device (such as an external display, speaker, or controller). Furthermore, the body device 200 may be a server which communicates with the controller 100. Alternatively, the body device 200 may be formed integrally with the controller 100.

### Effects

In the input device 1 according to the example embodiment, the input state of the input device 1, the degree to which the finger of the user is approaching the keycap 60, and the depression amount of the keycap 60 are detected based on the charge amount of the capacitor 17, and in particular, in the example embodiment, based on the number of repetitions of switching of the switches S₁, S₂, which change in accordance with the charge amount of the capacitor 17. Thus, an input by the user in the input device 1 can be detected with only one detection system, and complication of the detection system is prevented.

Furthermore, as shown in FIG. 4, in the input device 1 according to the example embodiment, the ground electrode 13 is configured so as to overlap the entirety of the moving electrode 33 when viewed in the axis line X direction. As a result, the capacitance between the moving electrode 33 and the ground electrode 13 is large. Furthermore, the moving electrode 33 is arranged on the movable part lower surface 24, which is on the side opposite from the keycap 60 side (i.e., the movable part upper surface 23). As a result, the moving electrode 33 can approach the ground electrode to the greatest extent possible, whereby the capacitance between the moving electrode 33 and the ground electrode 13 is increased. By increasing the capacitance between the moving electrode 33 and the ground electrode 13 in this manner, change in the charge amount of the capacitor 17 increases when the distance between the moving electrode 33 and the ground electrode 13 changes, making it easier to detect changes in the position of the movable part 21, and specifically, the pressing amount of the keycap 60.

Furthermore, in the example embodiment, the high potential electrode 15 is a linear electrode. Thus, the surface area of the ground electrode 13 facing the moving electrode 33 is greater than the surface area of the high potential electrode 15 facing the moving electrode 33. By forming the high potential electrode 15 thin and small relative to the ground electrode 13 in this manner, the capacitance between the moving electrode 33 and the high potential electrode 15 can be made sufficiently small so as to not influence the detection of the pressing amount, etc.

Though preferred embodiments according to the present disclosure have been described above, the present disclosure is not limited to these embodiments, and various modifications and changes can be made within the scope of the claims.

1. An input device, comprising:
a keycap configured to be depressed;
a first electrode configured to move in a specified direction in response to depression of the keycap;
a second electrode arranged facing the first electrode such that a capacitance between the first electrode and the second electrode changes in accordance with a depression amount of the keycap, the second electrode being connected to ground;
a chargeable capacitor;
a sensor part configured to detect a value of a charge parameter which changes in accordance with a charge amount of the capacitor;
a switching part configured to switch connection state between a first state in which a power supply and the first electrode are connected to each other and the first electrode and the capacitor are not connected to each other, and a second state in which the power supply and the first electrode are not connected to each other and the first electrode and the capacitor are connected to each other; and
a third electrode arranged so as to come into contact with the first electrode when a depression amount of the keycap is equal to or greater than a specified amount, the third electrode being connected to the power supply.

2. The input device according to claim 1, further comprising a fourth electrode arranged adjacent to a depressed surface of the keycap, the fourth electrode being electrically connected to the first electrode, wherein
the fourth electrode is configured such that, when a grounded conductor approaches thereto, a capacitance between the conductor and the fourth electrode changes.

3. The input device according to claim 1, wherein the second electrode and the third electrode are arranged facing each other with an insulation layer interposed therebetween.

4. The input device according to claim 3, wherein the second electrode is arranged within a substrate and the third electrode is arranged so as to be exposed on a surface of the substrate.

5. The input device according to claim 1, wherein a surface area of the second electrode facing the first electrode is greater than a surface area of the third electrode facing the first electrode.

6. The input device according to claim 5, wherein the third electrode is formed in a shape of one or a plurality of lines.

7. The input device according to claim 1, wherein the second electrode is configured so as to overlap an entirety of the first electrode when viewed in the specified direction.

8. The input device according to claim 1, further comprising a movable part arranged on the specified direction side of the keycap, the movable part moving in response to depression of the keycap, wherein
the first electrode is arranged on a surface of the movable part facing the second electrode on a side opposite the keycap side.

9. The input device according to claim 8, wherein the movable part is formed of an elastic material, and
the first electrode is formed of a deformable material.

10. The input device according to claim 9, wherein the first electrode is carbon ink sintered on a surface of the movable part.

11. The input device according to claim 1, wherein a specified voltage is applied to the third electrode by the power supply.

12. A system including the input device according to claim 1, the system comprising:
a state detection part configured to detect an input state in the input device based on a value of a charge parameter detected by the sensor part.

13. The system according to claim 12, wherein the state detection part detects, based on the value of the charge parameter detected by the sensor part, which of a first input state in which a grounded conductor is close to the keycap, a second input state in which the keycap is depressed, and a third input state in which the depression amount of the keycap is equal to or greater than the specified amount, the input state is.

14. The system according to claim 12, wherein the state detection part detects a depression amount of the keycap based on the value of the charge parameter detected by the sensor part.

15. The system according to claim 12, wherein the charge parameter is a count of times the switching part switches the connection state between the first state and the second state until the charge amount of the capacitor reaches a specified charge amount.
